(19) United States
(12) Patent Application Publication
(10) Pub. No.: US 2015/0086068 A1
(43) Pub. Date: Mar. 26, 2015

(54) Instrument and Document Authentication System

(71) Applicants: Patrick F.X. Mulhearn, Rye, NY (US); Michelle Mulhearn, Rye, NY (US); Michael Shutt, Princeton, NJ (US)

(72) Inventors: Patrick F.X. Mulhearn, Rye, NY (US); Michelle Mulhearn, Rye, NY (US); Michael Shutt, Princeton, NJ (US)

(21) Appl. No.: 14/491,941

(22) Filed: Sep. 19, 2014

Related U.S. Application Data
(60) Provisional application No. 61/960,504, filed on Sep. 20, 2013.

(51) Int. Cl. G06T 1/00

(52) U.S. Cl. CPC G06T 1/0021; G06T 2201/0062
USPC 382/100

(57) ABSTRACT

A method of creating a document whose authenticity can be confirmed comprises printing a character on the document using a combination of a printing medium having a first appearance and a contaminant having a second appearance distinct from the first appearance, and wherein a first portion of the character has the first appearance but not the second appearance, and a second portion of the character has the second appearance; capturing an image containing the character; and storing the image and information relating to the document in a database. A method of authenticating a document comprises capturing an image of the document; identifying a pattern in the document, comparing the pattern to information in a database relating to an original pattern present on an originally printed document, to determine whether the pattern and the original pattern are within a specified level of similarity.

### PRIORITY

This application claims the benefit of U.S. Provisional Patent Application Ser. No. 61/960,504 entitled “Instrument and Document Authentication System,” filed Sep. 20, 2013, the disclosure of which is incorporated herein by reference in its entirety.

### BACKGROUND OF THE INVENTION

Nations and private institutions safeguard financial instruments and other critical documents from counterfeiting. Specially manufactured paper, interwoven security fibers, hidden water marks and unique printing have all been used to frustrate duplication. These measures make forgery more difficult, but not impossible. Sophisticated criminal organizations continue to produce illicit financial instruments and identification documents. A successful, large scale counterfeiting enterprise could undermine a nation's currency and destabilize its government. Other widely circulated instruments, e.g., credit or debit cards and identification documents such as passports or driver's licenses, warrant similar protection. Any system intended to protect financial instruments and critical documentation in mass circulation must be: effective; accessible; and, affordable.

Today, virtually every merchant in the U.S. checks large currency by applying a special marker to the bill and holding it up to the light to verify security threads and water marks infused into the bill's paper. This methodology is highly effective but not infallible. Further, while each bill has a unique serial number there is no way to track a bill's handling through various transactions. The value of a nation's currency is directly impacted by the extent to which it is and can be undermined by counterfeiting. The wholesale substitution of a particular currency is expensive and disruptive, so it happens infrequently. If substitution could eliminate the threat that the currency could be compromised, every nation would act as soon as practicable.

The ability to verify and authenticate passports is also important to national security, as passports are often used in combination with currency or financial transactions. Credit and debit cards are also compromised as identities are “stolen.”

A system for printing the documents so that they cannot be duplicated, as well as a system for storing unique identifying information about a detail of the document that cannot be duplicated, would enhance security and reduce counterfeiting and other types of forgery and identity theft.

### SUMMARY OF THE INVENTION

The present invention is a system and method that provides a deterrent to financial instrument or document forgery through the use of mobile, recognition and radio frequency identification technologies. In one aspect of the present invention, a printing medium is purposefully contaminated with a reflective contaminant prior to printing the document. For the purposes of this patent, “a printing medium” is any substance used to print content onto a substrate, including, but not limited to, ink, toner, dye, pigment, etc. A “contaminant,” which can be a printing medium or some other substance, produces random patterns in the printing medium which can be detected by an image detector. Because they are random, they cannot be reproduced in a subsequent printing. They can, however, be stored in a database and that database can be queried to see if another document is a match for the random pattern.

A system applying these technologies separately and in tandem to the printing or fabrication process, especially of a serial number or any printed control sequencing method used to account for financial instruments or documentation, would allow a corresponding database to record, maintain, validate and attest to authentication of, for example, a particular bill, another financial instrument such as a bond or credit card, or identifying documentation such as a passport or license. The present system would operate on both authentication (an instrument or document is found in the database) as well as exclusion (an instrument or document can't be validated and, thus, is invalid until or unless otherwise authenticated). A government or private entity would oversee the database and operate as a clearinghouse to authenticate included instruments and documents.

In one aspect of the invention, a method of creating a document whose authenticity can be confirmed is disclosed. The method comprises the steps of, printing a character on the document using a combination, said combination comprising a printing medium having a first appearance and a contaminant having a second appearance, wherein the second appearance is distinct from the first appearance and wherein a first portion of the character has the first appearance but not the second appearance, and a second portion of the character has the second appearance; capturing an image containing the character; and storing the image and information relating to the document in a database. In one aspect of the invention, the first portion and the second portion are in random locations within the character. In one aspect of the invention, the printing medium or the contaminant is radio frequency conductive and the method further comprises the step of storing, in the database, radio frequency information relating to the document. In one aspect of the invention, the second appearance is distinct from the first appearance in a manner that is detectable through analysis of a photograph of the document taken with a camera within a smartphone.

In one aspect of the invention, a method of authenticating a document is disclosed. The method comprises the steps of capturing an image of the document; identifying a pattern in the document, the pattern including a first appearance and a second appearance wherein the second appearance is distinct from the first appearance, wherein a portion of the pattern has the first appearance and does not have the second appearance, and a second portion of the pattern has the second appearance; comparing the pattern to information in a database relating to an original pattern present on an originally printed document to determine whether the pattern and the original pattern are within a specified level of similarity; and outputting the result of the comparing step. In one aspect of the invention, the capturing step is performed by a device, the device comprising a camera and a memory containing computer executable code, said code capable of instructing the device to capture an image and to transfer the image to a computer in communication with the database. In one aspect of the invention, the device is a smartphone. In one aspect of the invention, the method further comprises the step of storing an identifier of said device to be associated with an attempt to authenticate a document. In one aspect of the invention, the method further comprises the steps of recording radio frequency information from the document and querying the database to determine whether the radio frequency information matches original radio frequency information, stored in the database, relating to the originally printed document.

In one aspect of the invention, the method further comprises the step of enforcing a rule to deny the authenticity of the document based on a characteristic of the document or a characteristic of an attempt to authenticate the document. In one aspect of the invention, the rule comprises determining whether a number of attempts to authenticate a document in the database exceeds a maximum number of attempts to authenticate a document in the database. In one aspect of the invention, the maximum number of attempts is a maximum number of attempts within a specified time period. In one aspect of the invention, the rule comprises determining whether a previous attempt to authenticate the document has been made at a geolocation further than a maximum acceptable distance from the geolocation at which the image was captured. In one aspect of the invention, the step of determining whether a previous attempt to authenticate the document has been made at a geolocation further than a maximum acceptable distance from the geolocation at which the image was captured is effective to deny the authenticity of the document only if the attempt to authenticate the document and the previous attempt occur within a specified length of time. In one aspect of the invention, the pattern is contained in a character.

### BRIEF DESCRIPTION OF THE DRAWINGS

FIG. 1 is a flow chart of a method in accordance with one aspect of the present invention.

FIG. 2 is a flow chart of a method in accordance with one aspect of the present invention.

FIG. 3 is a diagram of a system architecture in accordance with one aspect of the present invention.

### DETAILED DESCRIPTION OF ASPECTS OF THE INVENTION

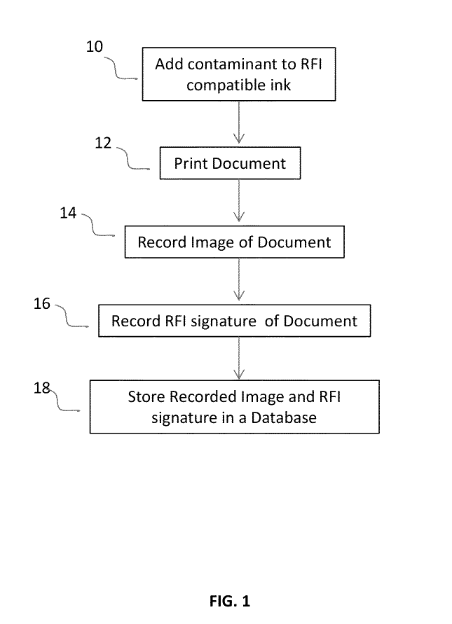

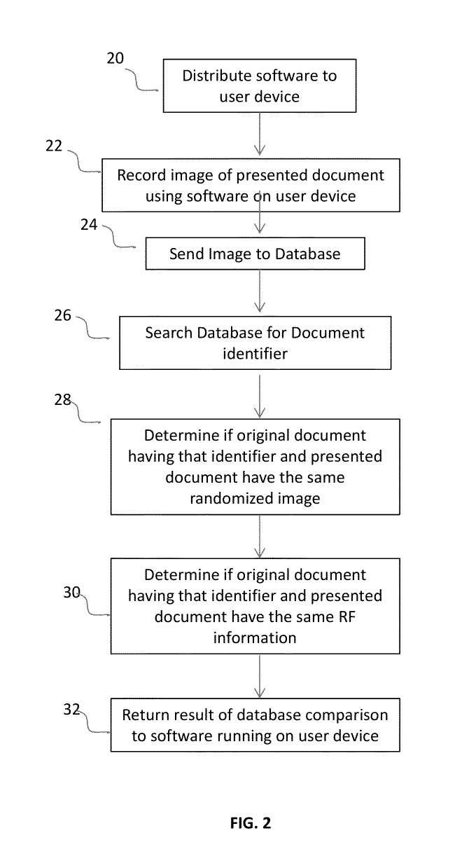

The subject matter that is regarded as the invention is particularly pointed out and distinctly claimed in the concluding part of the specification. The invention, however, may be best understood by reference to the following description taken in conjunction with the accompanying representations in which FIG. 1 and FIG. 2 are block diagrams of aspects of the instrument or document authentication system.

In one aspect of the invention, a contaminated printing medium is used. A printing medium would be mixed with a contaminant that, when combined, produces a random pattern each time the same character, word, image, etc. is printed. In one aspect of the invention, the contaminant is reflective, and specks of reflective material are printed along with the printing medium. The contaminant is such that it does not interfere with the printing process for the printers that are conventionally used to print with the type of printing medium used, and therefore no special printing equipment is necessary. However, each time an item is printed, the distribution of contaminant into a pattern will be different because the contaminant is free-floating and random. Thus, if the same character is printed on two documents, that character in each document would have different patterns of reflection caused by the contaminant.

In one aspect of the invention, the contaminant is made up of free-floating reflective particles, a contrasting color, or another substance. Persons having ordinary skill in the art will realize that different types of printing medium, contaminant, and contamination processes can be used to achieve the result, which is a contaminated printing medium causing randomized patterns in the printed characters, such that the contaminant impacts the reflected light (white/polychrome illumination or specific monochromatic one), its amplitude statistical distribution, and/or another property of the final printed product such that the printing medium can be distinguished from the contaminant. In one aspect of the invention, the contaminant would increase the light reflected amplitudes which would, in turn, change distribution parameters and shape.

The pattern caused by the contaminant in the printing medium can be recognized by image recognition technology, and two patterns can be compared for similarity with varying degrees of precision. In one aspect of the invention, a matching algorithm calculates a similarity measure between images based on the Bayesian Mean Risk metrics and its different approximations specifically for the given physical observations. In one aspect of the invention, high speed binary, amplitude independent features are used for pattern recognition. In one aspect of the invention, the printing medium would be an electrically conductive printing medium capable of conducting radio frequency (“RF”) waves that can be read using a Radio Frequency Identification (“RFID”) reader. Persons having skill in the art would realize that the reflective additive can be used with an RF capable printing medium and with a printing medium that is not RF capable.

In one aspect of the invention, the contaminated printing medium would be used to print the identifier of the document, e.g., a serial number on a currency note. Accordingly, the document could then be identified by its serial number and then that serial number can be linked to the pattern of reflective material contained within the document when the document bearing that serial number was printed.

Turning now to FIG. 1, a flow chart of a method in accordance with one aspect of the invention is shown. In step 10, the contaminant is added to the printing medium. As discussed above, the contaminant is a reflective element, and in one aspect either the printing medium or the contaminant, or both, is also Radio Frequency Identification Element (“RFIE”) or Radio Frequency Identification Ink (“RFII”) compatible as well. The reflective element generates a random pattern or image within the printed characters. In step 12, the document is printed with the contaminated printing medium. In one aspect, the document is printed with an identifier such as a serial number, and the identifier is printed with the contaminated printing medium. In step 14 an image of the identifier is recorded. The stored image will contain the randomized pattern created by the contaminated printing medium. In step 16, in one aspect of the invention, the document's RFI signature can also be recorded. Persons having skill in the art will realize that this is an optional step, in that the reflective contaminated printing medium can be used with non-RFII as well. In step 18, the image and the RFI signature, if used, are stored in a centralized database for all documents using the printing medium of the present invention, or decentralized databases or document specific databases can be used in the database.

Turning now to FIG. 2, wherein a flow chart of a method in accordance with one aspect of the present invention is shown. Software for devices which contain or can be connected to cameras, such as cellular telephones, smartphones, tablets, or computers, can be distributed and installed in step 20. These devices can be held and used by retailers, travel desk personnel, notaries public, property closing agents, or any other person needing to authenticate documents. Persons having ordinary skill in the art will realize that this software can take various forms including executable code and can be stored in various places including on the device or on the internet. In one aspect of the invention, installation of the software is accompanied by registration of a unique identifier of the device. Other information for the device, including subscriber names and telephone numbers, can also be registered.

This software, in communication with a camera that is connected to or accessible by the device on which the software is installed, can record a photo of a document purporting to be an original that is recorded in the database in accordance with one aspect of the present invention in step 22. The software would send the photo to the database or another server or computing device in communication with the database in step 24. The database is then searched for the document identifier (e.g., serial number) in step 26 and also for a match to the image that was randomly created when the document was printed in step 28. A secondary check using Radio Frequency Identification Technology (“RFIT”) can also be used in step 30. The software then returns the result of the comparison to the user device running the software, which confirms whether the document contains the same randomized image as was contained in the identifier when it was originally printed in step 32.

Additional information can be stored with respect to the documents whose images are stored in the database. For example, information relating to the type of document can be stored. Information relating to each attempt to authenticate a document purporting to match the document can be stored, including its geolocation, its time, and the identification of the device attempting to authenticate the document. Accordingly, rules can be used by the database or any computer or other device in communication with the database, that determine whether the document is deemed authentic. Documents can be rejected based on violation of a security rule, despite its image matching the stored image within the required variance threshold, which itself can be determined by users in various capacities, e.g., database administrator, retailer, etc.

For example, if a document is deemed to have been queried in the database too many times in a particular time period, its authenticity might be rejected. If a document is deemed to have been queried in multiple locations too far away from each other within a specified time period, its authenticity might be rejected. In another aspect of the invention, different security rules can be used for different types of documents. For example, some documents circulate, such as currency, while other documents are personal to the owner and therefore should always be carried by the same person, such as a passport. Accordingly, different security rules can be used. In another aspect, the information relating to the frequency, time, and/or location of the prior attempts to authenticate the same document might be sent to the user device where the user of that device can make a determination regarding whether to accept the document as authentic.

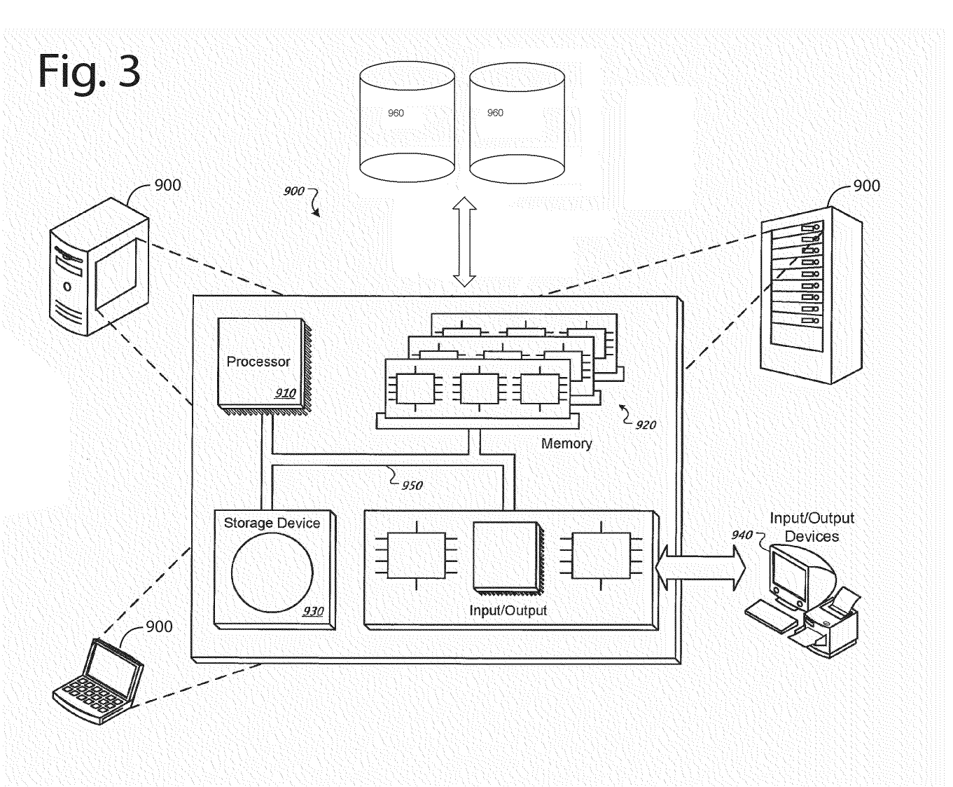

FIG. 3 is a diagram displaying a general purpose computer on which the system and method of the present disclosure may be implemented according to an aspect of present disclosure. The computer system 900 may execute at least some of the operations described above. Computer system 900 may include processor 910, memory 920, storage device 930, and input/output devices 940. Some or all of the components 910, 920, 930, and 940 may be interconnected via system bus 950. Processor 910 may be single or multi-threaded and may have one or more cores. Processor 910 may execute instructions, such as those stored in memory 920 or in storage device 930. Information may be received and output using one or more input/output devices 940.

Memory 920 may store information and may be a computer-readable medium, such as volatile or non-volatile memory. Storage device 930 may provide storage for system 900 and may be a computer-readable medium. In various aspects, storage device 930 may be a flash memory device, a floppy disk device, a hard disk device, an optical disk device, or a tape device.

Input/output devices 940 may provide input/output operations for system 900. Input/output devices 940 may include a keyboard, pointing device, and microphone. Input/output devices 940 may further include a display unit for displaying graphical user interfaces, speaker, and printer. External data, such as financial data, may be stored in accessible external databases 960.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable, disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the described one. The relationship of client and server may arise by virtue of computer programs running on the respective computers and having a client-server relationship to each other.

Numerous additional modifications and variations of the present disclosure are possible in view of the above teachings. It is therefore to be understood that within the scope of the appended claims, the present disclosure may be practiced other than as specifically described herein.

Persons having skill in the art will realize that the embodiments disclosed herein are exemplary, and that deviations from same without altering the primary features of the invention may also permit the invention, and/or one or more aspects of same, to perform its intended function of creating randomized reflective patterns within a printing medium that can be detected and queried for matches in a database.

1. A method of creating a document whose authenticity can be confirmed, said method comprising the steps of:
a) printing a character on the document using a combination, said combination comprising a printing medium having a first appearance and a contaminant having a second appearance, wherein the second appearance is distinct from the first appearance and wherein a first portion of the character has the first appearance but not the second appearance, and a second portion of the character has the second appearance;
b) capturing an image containing the character; and
c) storing the image and information relating to the document in a database.

2. The method of claim 1, wherein the first portion and the second portion are in random locations within the character.

3. The method of claim 1, wherein the printing medium or the contaminant is radio frequency conductive, said method further comprising the step of: storing, in the database, radio frequency information relating to the document.

4. The method of claim 1, wherein the second appearance is distinct from the first appearance in a manner that is detectable through analysis of a photograph of the document taken with a camera within a smartphone.

5. A method of authenticating a document comprising the steps of:
a) capturing an image of the document;
b) identifying a pattern in the document, the pattern including a first appearance and a second appearance wherein the second appearance is distinct from the first appearance, wherein a portion of the pattern has the first appearance and does not have the second appearance, and a second portion of the pattern has the second appearance;
c) comparing the pattern to information in a database relating to an original pattern present on an originally printed document to determine whether the pattern and the original pattern are within a specified level of similarity; and
d) outputting the result of the comparing step.

6. The method of claim 5, wherein the capturing step is performed by a device, the device comprising a camera and a memory containing computer executable code, said code capable of instructing the device to capture an image and to transfer the image to a computer in communication with the database.

7. The method of claim 6 wherein the device is a smartphone.

8. The method of claim 6, further comprising the step of storing an identifier of said device to be associated with an attempt to authenticate a document.

9. The method of claim 5, further comprising the steps of recording radio frequency information from the document and querying the database to determine whether the radio frequency information matches original radio frequency information, stored in the database, relating to the originally printed document.

10. The method of claim 5, further comprising the step of: enforcing a rule to deny the authenticity of the document based on a characteristic of the document or a characteristic of an attempt to authenticate the document.

11. The method of claim 10, wherein the rule comprises determining whether a number of attempts to authenticate a document in the database exceeds a maximum number of attempts to authenticate a document in the database.

12. The method of claim 11, wherein said maximum number of attempts is a maximum number of attempts within a specified time period.

13. The method of claim 10, wherein the rule comprises determining whether a previous attempt to authenticate the document has been made at a geolocation further than a maximum acceptable distance from the geolocation at which the image was captured.

14. The method of claim 13 wherein said step of determining whether a previous attempt to authenticate the document has been made at a geolocation further than a maximum acceptable distance from the geolocation at which the image was captured is effective to deny the authenticity of the document only if the attempt to authenticate the document and the previous attempt occur within a specified length of time.

15. The method of claim 5, wherein the pattern is contained in a character.
